(19) United States
(12) Patent Application Publication
(10) Pub. No.: US 2017/0091335 A1
(43) Pub. Date: Mar. 30, 2017

(54) SEARCH METHOD, SERVER AND CLIENT

(71) Applicant: Tencent Technology (Shenzhen) Company Limited, Shenzhen (CN)

(72) Inventors: Yang LIU, Shenzhen (CN); Xiaolong ZHANG, Shenzhen (CN); Junbin KUANG, Shenzhen (CN); Yuxuan ZHANG, Shenzhen (CN); Wei LUO, Shenzhen (CN); Beiqi WU, Shenzhen (CN); Leyu LIN, Shenzhen (CN)

(21) Appl. No.: 15/208,387

(22) Filed: Jul. 12, 2016

Related U.S. Application Data
(63) Continuation of application No. PCT/CN2015/091010, filed on Sep. 29, 2015.

(51) Int. Cl. G06F 17/30

(52) U.S. Cl. CPC G06F 17/30867; G06F 17/3053; G06F 17/30554; G06F 17/3056

(57) ABSTRACT

A search method, a server and a client are provided. A first-order search keyword and a user identifier are received from a social application client to search for information relevant to the first-order search keyword. A search result comprising at least one piece of information and social relationship information corresponding to the user identifier in the social application are obtained. Information in the search result is ranked based on the social relationship information to obtain a search result rank list and the search result rank list is sent to the social application client.

### CROSS-REFERENCE TO RELATED APPLICATIONS

This application is a continuation of International Application No. PCT/CN2015/091010, filed on Sep. 29, 2015, which claims priority to Chinese Patent Application No. 201410391655.6 titled “SEARCH METHOD, SERVER AND CLIENT” and filed with the Chinese State Intellectual Property Office on Aug. 8, 2014, both of which are incorporated herein by reference in their entirety.

### FIELD

The present disclosure relates to the field of information technology, and in particular to a search method, a server and a client.

### BACKGROUND

With the development and popularization of information technology, the internet is filled with diversified information resources. In order to find desired information from numerous information resources, a user can find information relevant to a keyword by searching with the keyword. Since different information is different in importance and an information distinguishing ability of the user is limited, it is a key to provide a quick search method to facilitate browsing of the user.

A conventional method for implementing a search includes: searching for information relevant to a keyword inputted by a user, to obtain multiple pieces of information corresponding to the keyword, ranking the multiple pieces of information obtained by searching according to the relevancy between the multiple pieces of information and the keyword, where information more relevant to the keyword is ranked at the top and information less relevant to the keyword is ranked at the bottom.

In the process of implementing the search, after a search result relevant to the keyword inputted by the user is obtained, the user, whose demand may be different from others, needs to browse the search result relevant to the keyword to obtain desired information. Hence, the search method above is not quick enough in implementation, targeted or flexible.

### SUMMARY

In view of the above, a search method, a server and a client are provided according to the present disclosure.

In an aspect, a search method is provided, which is applied to information search in a social application. The search method includes; receiving a first-order search keyword and a user identifier from a social application client; searching for information relevant to the first-order search keyword, to obtain a search result including at least one piece of information; obtaining social relationship information corresponding to the user identifier and ranking information in the search result based on the social relationship information, to obtain a search result rank list; and sending the search result rank list to the social application client.

In an aspect, a search method is provided, which includes: obtaining a user identifier of a user and a first-order search keyword inputted by the user, sending the first-order search keyword and the user identifier to a social application server; receiving a search result rank list from the social application server, where the search result rank list is obtained by ranking, by the social application server, information corresponding to the first-order search keyword based on social relationship information corresponding to the user identifier; and displaying the search result rank list received from the social application server.

In an aspect, a social application server is provided, which is applied to information search in a social application. The social application server includes: a first receiving module, configured to receive a first-order search keyword and a user identifier from a social application client; a first searching module, configured to search for information relevant to the first-order search keyword, to obtain a search result including at least one piece of information; an obtaining module, configured to obtain social relationship information corresponding to the user identifier; a first ranking module, configured to rank information in the search result based on the social relationship information, to obtain a search result rank list; and a first sending module, configured to send the search result rank list to the social application client.

In an aspect, a social application client is further provided, which is applied to information search in a social application. The social application client includes: a first obtaining module, configured to obtain a user identifier of a user and a first-order search keyword inputted by the user; a first sending module, configured to send the first-order search keyword and the user identifier to a social application server, a first receiving module, configured to receive a search result rank list from the social application server, where the search result rank list is obtained by ranking, by the social application server, information corresponding to the first-order search keyword based on social relationship information corresponding to the user identifier, and a first displaying module, configured to display the search result rank list received from the social application server.

### BRIEF DESCRIPTION OF THE DRAWINGS

The drawings to be used in the descriptions of embodiments are described briefly as follows, so that technical solutions according to the embodiments of the invention may become clearer Apparently, the drawings in the following descriptions only illustrate some embodiments of the invention. For those in the art, other drawings may be obtained based on these drawings without any creative work.

FIG. 1 is a schematic diagram of an implementation environment related to a search method according to an embodiment of the invention;

FIG. 2 is a flowchart of a search method according to an embodiment of the invention;

FIG. 3 is a flowchart of a search method according to another embodiment of the invention;

FIG. 4 is a flowchart of a search method according to still another embodiment of the invention;

FIG. 5 is a flowchart of a search method according to still another embodiment of the invention;

FIG. 6 is a schematic diagram of an interface for inputting a keyword according to an embodiment of the invention;

FIG. 7 is a schematic diagram of a display interface according to an embodiment of the invention;

FIG. 8 is a schematic diagram of a display interface according to another embodiment of the invention;

FIG. 9 is a schematic diagram of a display interface according to still another embodiment of the invention;

FIG. 10 is a structural diagram of a social application server according to an embodiment of the invention;

FIG. 11 is a structural diagram of a first ranking module according to an embodiment of the invention;

FIG. 12 is a structural diagram of a second ranking unit according to an embodiment of the invention;

FIG. 13 is a structural diagram of a social application server according to another embodiment of the invention;

FIG. 14 is a structural diagram of a social application server according to still another embodiment of the invention;

FIG. 15 is a structural diagram of a social application client according to an embodiment of the invention;

FIG. 16 is a structural diagram of a first displaying module according to an embodiment of the invention;

FIG. 17 is a structural diagram of a social application client according to another embodiment of the invention;

FIG. 18 is a structural diagram of a social application client according to still another embodiment of the invention;

FIG. 19 is a structural diagram of a terminal according to an embodiment of the invention; and

FIG. 20 is a structural diagram of a search system according to an embodiment of the invention.

### DETAILED DESCRIPTION

Technical solutions according to embodiments of the invention are described clearly and completely hereinafter in conjunction with the drawings, so that the objective, technical solutions and advantages of the invention may become clearer.

As used herein, an application is software, firmware or a combination of software and hardware for implementing specific functions.

As used herein, a social application is an application for implementing social functions based on online user recognition and information exchanging technology with a mobile terminal such as a cellphone or a tablet computer serving as a carrier.

As used herein, social relationship information corresponding to an identifier in an social application may include profile information registered in the social application by a user corresponding to the identifier, a behavior of the user corresponding to the identifier in the social application, other users related to the user corresponding to the identifier in the social application, or behaviors of the other related users in the social application or arbitrary combinations of the above.

According to some embodiments, the social relationship information includes but is not limited to social behavior information of a user and social behavior information of other users related to the user. The social relationship information corresponding to the identifier may include information of a group and a location which the user is in, such as a school the user attends or a location the user stays, history behaviors of the user, such as, hotspot information the user paid attention to, or information of other users related to the user, such as information of friends the user often contacts with, articles shared by friends of the user or blogs written by friends of the user. The contents of the social relationship information corresponding to the identifier are not limited in the embodiment of the invention.

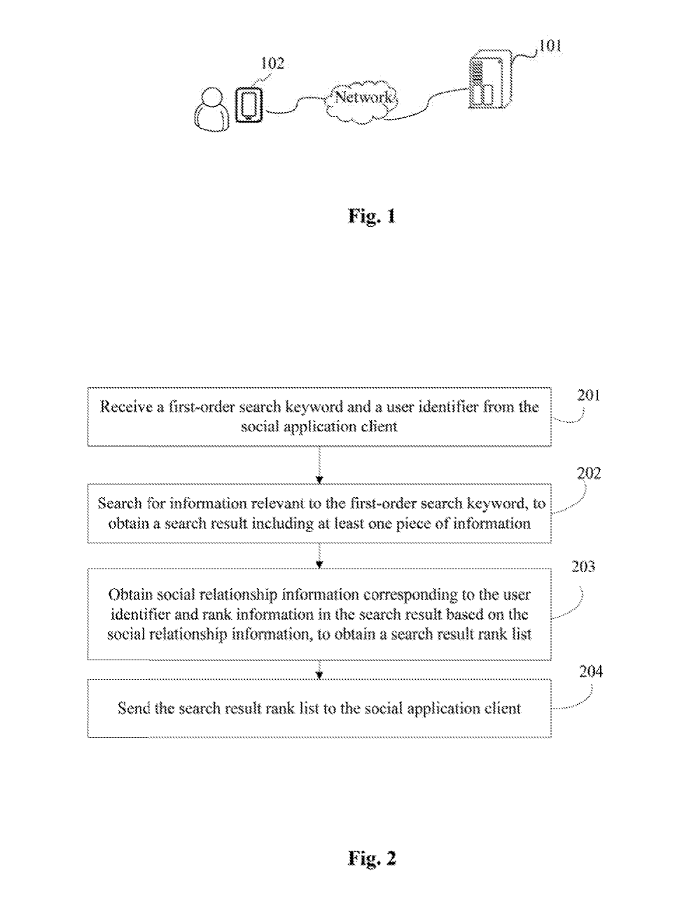

FIG. 1 shows a schematic diagram of an implementation environment related to a search method according to an embodiment of the invention. As shown in FIG. 1, the implementation environment includes a social application server 101 and a social application client 102, where the social application server 101 and the social application client 102 are connected with each other through a wireless network or a wired network.

In conjunction with embodiment above, a search method is provided according to an embodiment of the invention. As shown in FIG. 2, the search method according to the embodiment includes:

201, receiving a first-order search keyword and a user identifier from the social application client;

202, searching for information relevant to the first-order search keyword, to obtain a search result including at least one piece of information;

203, obtaining social relationship information corresponding to the user identifier in the social application and ranking information in the search result based on the social relationship information, to obtain a search result rank list; and

204, sending the search result rank list to the social application client.

In conjunction with schematic diagram of the implementation environment in FIG. 1, a search method is provided according to another embodiment of the invention. As shown in FIG. 3, the search method according to the embodiment includes:

301, obtaining a user identifier of a user and a first-order search keyword inputted by the user;

302, sending the first-order search keyword and the user identifier to the social application server;

303, receiving a search result rank list from the social application server, where the search result rank list is obtained by ranking, by the social application server, information corresponding to the first-order search keyword based on social relationship information corresponding to the user identifier in the social application; and

304, displaying the search result rank list received from the social application server.

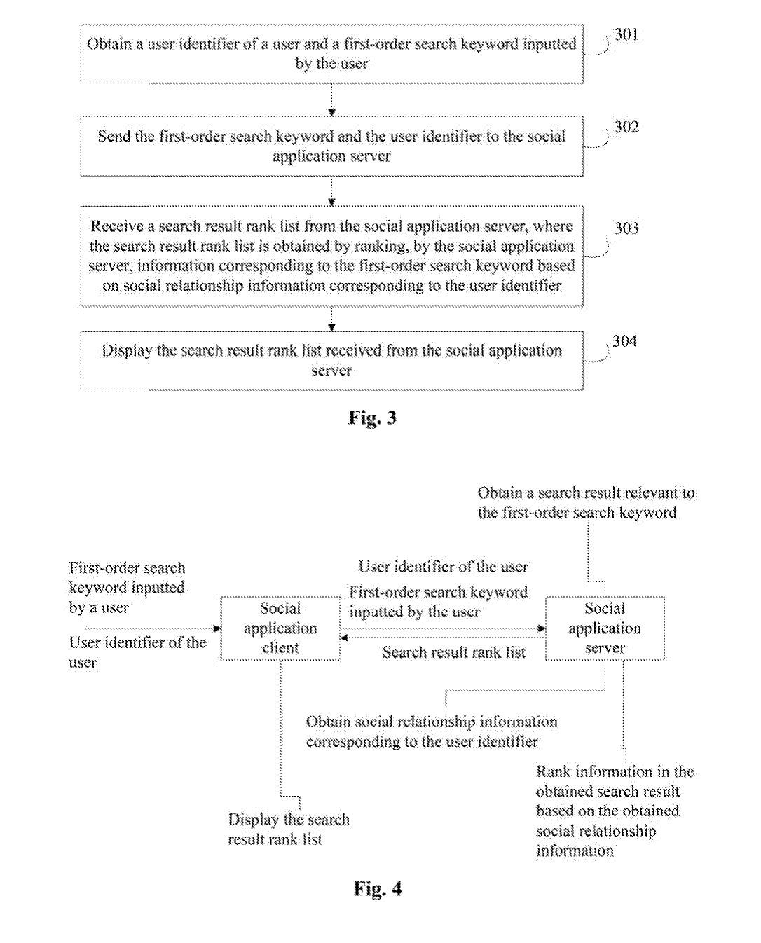

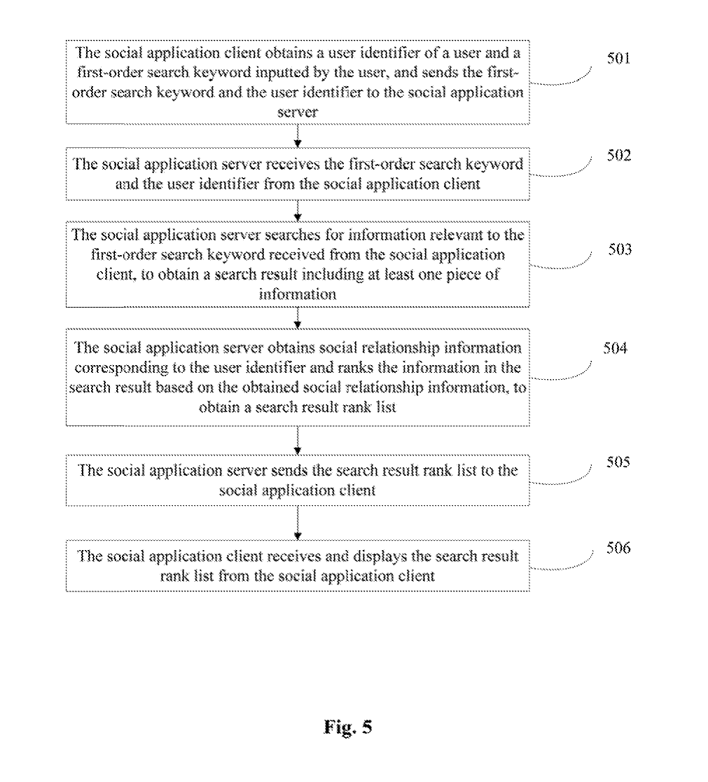

In conjunction with schematic diagram of the implementation environment in FIG. 1, the embodiments as shown in FIG. 2 or 3 and a schematic diagram of a search interaction shown in FIG. 4, a search method is provided according to another embodiment of the invention. As shown in FIG. 5, the search method according to the embodiment includes steps 501 to 506.

In step 501, the social application client obtains a user identifier of a user and a first-order search keyword inputted by the user, and sends the first-order search keyword and the user identifier to the social application server.

Contents and a length of the first-order search keyword inputted by the user are not limited in the embodiment of the invention. The method for the social application client to obtain the first-order keyword inputted by the user includes but is not limited to receiving keyword information through a search interface in a client of a social tool, and the method for obtaining the first-order search keyword is not limited in the embodiment of the invention.

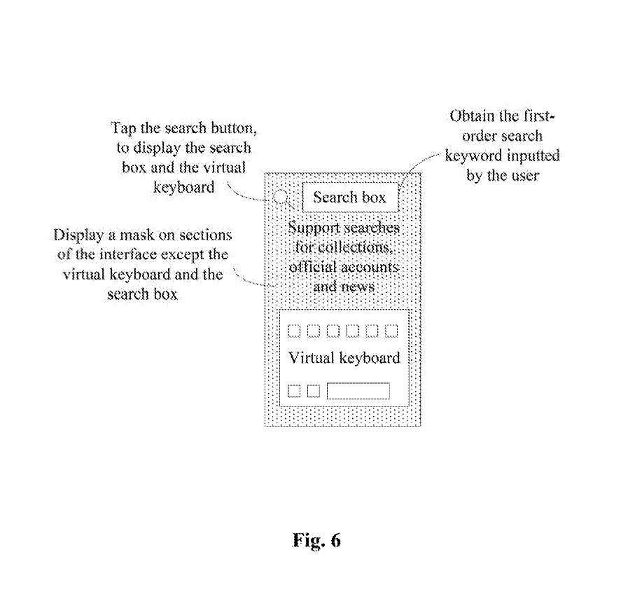

The search interface in the client of the social tool may be displayed on a visual user interface in the form of a search box, for example, a interface for inputting a keyword shown in FIG. 6. When inputting the first-order search keyword, the user needs to tap a search button and thereafter a virtual keyboard is displayed on the interface for the user to perform inputting. Besides, a mask is displayed at the same time on sections of the interface except the virtual keyboard and the search button, to temporally cover contents except those in the virtual keyboard and the search button. The mask displayed on the interface may present any display effect such as an effect of ground glass.

In addition, the user identifier of the user may be an IP (internet protocol) address of the user, or a nickname or an identity of the user in the social tool, where the user identifier is not limited in the embodiment of the invention.

The method for the social application terminal to obtain the user identifier includes but is not limited to: obtaining, by the social application client, the user identifier of the user according to preset obtaining process automatically when detecting that the user is logging onto the social application through a terminal.

Further, the method for the social application client to send the first-order search keyword and the user identifier to the social application server includes but is not limited to: sending, by the social application client, the first-order search keyword and the user identifier to the social application server when detecting that no input is received from the user for a predetermined time after the user has input at least two characters for the first-order keyword. Herein sending the first-order search keyword and the user identifier to the social application server when no input is received from the user for a predetermined time is for confirming that an input operation of the user is finished. The predetermined time is not specifically limited in the embodiment of the invention, and may be determined according to practical circumstances in practical implementations.

In an optional embodiment, when the user inputs the first-order search keyword, only the search box and the virtual keyboard are displayed on the display interface of the social application client. When the user finishes inputting the keyword and wants to return, the user can return just by swiping left on the interface with his finger. In this case the virtual keyboard is hidden but the search box is still on the display interface of the social application client.

The method for sending the first-order search keyword and the user identifier to the social application server is not limited in the embodiment. Since the social application client and the social application server are connected to each other through a wired network or a wireless network, the social application client may but is not limited to pack the first-order search keyword and the user identifier into a data packet and then send the data packet to the social application server through the wired network or the wireless network.

In step 502, the social application server receives the first-order search keyword and the user identifier from the social application client.

The method for the social application server to receive the first-order search keyword and the user identifier from the social application client is not limited in the embodiment. Since the social application client and the social application server are connected to each other through the wired network or the wireless network, the social application server can receive the first-order search keyword and the user identifier through the wired network or the wireless network after the social application client obtains the user identifier and the first-order search keyword inputted by the user and sends the first-order search keyword and the user identifier to the social application server through the wired network or the wireless network.

In step 503, the social application server searches for information relevant to the first-order search keyword received from the social application client, to obtain a search result including at least one piece of information.

The information relevant to the first-order search keyword may be any information including the first-order search keyword, which is not limited in the embodiment of the invention and may be accounts, official accounts and articles including the first-order search keyword in the social application, for example.

In an optional embodiment, in order to avoid that relevant information has to be obtained from numerous information resources every time, before the social application server searches information relevant to the first-order search keyword from the social application client, the search method further includes: collecting information resources, extracting index information of the information resources and storing the index information of the information resources, to generated an index information base, so that the information relevant to the first-order search keyword can be searched for in the index information base, to obtain a search result including at least one piece of information.

The collected information resources may be one or more information resources stored in a network or the client, for example, various types of webpages. Besides, there may be one or more hyperlinks in a webpage which link to other webpages, and sources, contents and the number of the collected information resources are not limited in the embodiment of the invention.

In a case the information resources are webpages, the method for collecting the information resources may include but is not limited to: determining a few existing webpages as initial webpages, collecting contents of the initial webpages, recording data of hyperlinks in the initial webpages and linking to other webpages via the hyperlinks in the initial webpages; collecting contents of the linked webpages, determining whether the linked webpages include hyperlinks, if yes, recording data of hyperlinks in the linked webpages and linking further to other webpages via the hyperlinks in the linked webpages, otherwise finishing visiting; and performing visiting and collecting on the further linked webpages, to obtain information relevant to the first-order search keyword.

Specifically, policies for collecting contents of webpages and data of hyperlinks may include but are not limited to the following two collecting policies.

A first collecting policy is a depth-first policy. A hyperlink is selected in an initial webpage, and the other hyperlinks in the initial webpage are ignored. A second webpage is reached via the hyperlink as selected in the initial webpage, and data of the hyperlink is recorded. Contents of the second webpage are collected. A hyperlink in the second webpage is selected, and the other hyperlinks in the second webpage are ignored. A third webpage is reached via the hyperlink as selected in the second webpage, and data of the hyperlink is recorded. Contents of the third webpage are collected. The process continues to collect contents of webpages and data of hyperlinks according to the steps above until there is no hyperlink in a collected current webpage. It is returned to a previous webpage in which a hyperlink corresponding to the collected current webpage is located in a case there is no hyperlink in the collected current webpage. It is determined whether there is any hyperlink other than the hyperlink corresponding to the collected current webpage in the previous webpage. If yes, another hyperlink in the previous webpage is selected to continue the collecting operation above; otherwise it is returned to a webpage in which a hyperlink corresponding to the previous webpage is located to continue the determining and collecting operations.

For example, an initial webpage is webpage A and there are webpage B, webpage C, webpage D and webpage E in order along hyperlinks in webpages. There are ten hyperlinks in webpage A, which are represent by A1, A2 . . . A10; there are ten hyperlinks in webpage B as well, which are represented by B1, B2 . . . B10; similarly, there are ten hyperlinks in each of webpage C and webpage D as well, which are represented in a manner in which hyperlinks in webpages A and B are represented; and there is no hyperlink in webpage E. A1 links to webpage B, B1 links to webpage C, C1 links to webpage D and D1 links to webpage B. In collecting according to the depth-first policy, data of hyperlinks A1, B1, C1 and D1 are recorded preferentially and webpages A, B, C, D and E are collected preferentially. Since there is no hyperlink in webpage E, i.e., the link path starting from A1 is over, recording and collecting are performed preferentially on a deeper webpage through hyperlink D2 in webpage D which is the deepest in the link path starting from A1. Similarly, recording and collecting are performed on a deeper webpage from the current deepest webpage, every time.

A second collecting policy is a width-first policy. The initial webpages are taken as first-layer webpages. Accordingly, webpages corresponding to hyperlinks in the initial webpages are taken as second-layer webpages, and webpages corresponding to hyperlinks in the second-layer webpages are taken as third-layer webpages and so on. Contents of the first-layer webpages are collected, and data of all the hyperlinks in the first-layer webpages is recorded. The second-layer webpages are reached via the hyperlinks in the first-layer webpages and contents of all the second-layer webpages are collected. And data of all the hyperlinks in the second-layer webpages is recorded. The third-layer webpages are reached via the hyperlinks in the second-layer webpages and contents of all the third-layer webpages are collected. Contents of fourth-layer webpages and webpages in deeper layers are collected in the same way, where contents of webpages in a layer are collected after contents of webpages in a previous layer are collected.

For example, an initial webpage is webpage A and there are two hyperlinks in webpage A, A1 and A2, where A1 corresponds to webpage B and A2 corresponds to webpage C. There are a hyperlink B1 and a hyperlink C1 in webpages B and C, respectively, where the hyperlink B1 corresponds to webpage D and the hyperlink C1 corresponds to webpage E. In this case, webpage A is the first-layer webpage, webpages B and C are the second-layer webpages and webpage D and E are the third-layer webpages. According to the width-first policy, the first-layer webpage A is collected preferentially, then the second-layer webpages B and C are collected and then the third-layer webpages D and E are collected. That is, after contents of all webpages in one layer are collected, contents of webpages in a next layer are collected. Data of hyperlinks corresponding to webpages is recorded as the webpages are collected.

Besides the two collecting policies above, other collecting policies may be adopted for collecting contents of webpage and data of hyperlinks. Policies for collecting contents of webpages and data of hyperlinks are not specifically limited in the embodiment of the invention.

It should be noted that since webpages and links in the webpages are always changing dynamically, it may be advantageous to start visiting from the initial webpages again every time after a period of time and determine, based on collected contents of webpages and recorded data of hyperlinks, whether each collected webpage has a content update, exists still, includes a new hyperlink or has an original hyperlink deleted. In a case a webpage collected last time has a content update, contents of the webpage will be collected again. In a case a webpage collected last time no longer exists, contents of the webpage collected last time are deleted. In a case a webpage collected last time includes a new hyperlink, data of the new hyperlink is recorded and visiting and collecting are further performed on a webpage the new hyperlink links to. In a case a webpage collected last time has an original hyperlink deleted, data of the original hyperlink recorded last time and contents (which are collected last time) of a webpage the original hyperlink links to are deleted.

It should be noted that the few existing webpages may be webpages within a certain IP address range, which is not limited in the embodiment of the invention.

Further, the extracting index information of the information resources includes performing word segmenting, performing webpage duplicate checking and extracting keyword information of webpages. And the method for extracting the index information of the information resources is not limited in the embodiment of the invention.

The word segmenting is mainly directed to contents of Chinese webpages. Since Chinese words differ from English words in that there are no spaces serving as separators between Chinese words, it is required to perform word segmenting on contents of Chinese webpages, to correctly separate human names, place names and words in the contents of the Chinese webpages according to respective contexts, so that index information relevant to the webpages can be obtained by extracting keyword from the result obtained through the separating. The method for performing the word segmenting on Chinese may include matching a sentence on which word segmenting is to be performed with vocabulary entries in a pre-built vocabulary entry base, and the matching may be performed according to a minimum segmentation principle so that the number of words obtained from the sentence through word segmenting is minimum. The webpage duplicate checking includes deleting webpages having the same contents as a certain webpage from the collected webpages. Extracting the keyword information of the webpages includes extracting relevant information such as frequencies, positions, fonts, sizes and colours of words, determining which of the words are keywords in the webpages and extracting the keywords in the webpages. Methods for word segmenting, performing webpage duplicate checking and extracting keyword information of webpages are not limited in the embodiment of the invention.

Further, the method for storing the index information of the information resources to generate the index information base includes but is not limited to: generating the index information in tabular form with the keywords extracted in the webpages and storing the generated index information to generate the index information base. The index information base generated by storing the index information of the information resources includes index information of all the collected information resources and complete information resources corresponding to the index information can be found with the index information.

Obtaining the information relevant to the first-order search keyword by searching the index information base includes: determining whether there is any index information including the first-order search keyword or identical with the first-order search keyword in the index information base, to obtain index information including the first-order search keyword.

For example, in a case the first-order search keyword inputted by the user is “alumni association”, index information including “alumni association”, “alumni association of ** University” or “alumni” will be obtained.

Since complete information resources corresponding to the index information can be found with the index information in the index information base, complete information resources corresponding to the first-order search keyword can be found with the index information including the first-order search keyword, thereby obtaining a search result including at least one piece of information.

In an optional embodiment, after the social application server obtains the search result, information in the search result obtained by the social application server may be arranged in a random order or an order with a certain ranking rule. With the certain ranking rule the information in the search result may be ranked according to relevancy to the first-order search keyword, to obtain a ranked search result. For example, information more relevant to the first-order search keyword is ranked at the top and information less relevant to the first-order search keyword is ranked at the bottom; or information of higher importance is ranked at the top and information of lower importance is ranked at the bottom. No matter how to rank the information according to relevancy, the ranking rule is used to weigh relevancy between the first-order search keyword and different information in the information relevant to the first-order search keyword, to weigh importance of different information. For example, in a case the information is webpages, a ranking algorithm may be formulated based on positions and frequency of the first-order search keyword appearing in the webpages relevant to the first-order search keyword, content qualities of the webpages and content qualities of other webpages linked to via hyperlinks in the webpages relevant to the first-order search keyword, to rank the webpages. Different weights can be assigned to factors affecting importance of a webpage, and a score calculating rule can be formulated to calculate scores of the factors affecting importance of a webpage in different webpages. Scores of the factors affecting importance of each webpage are multiplied by the weights thereof, respectively, to obtain products corresponding to the factors, and all the products are added up to obtain an importance score of each of the webpages. Webpages with higher importance scores are ranked at the top and webpages with lower importance scores are ranked at the bottom, to obtain a ranking result of the webpages. The ranking rule is not limited in the embodiment of the invention.

Of course, the information in the search result may be ranked according to the initial letter in each piece of information. The method for ranking the information in the search result is not limited in the embodiment of the invention. In order to obtain a search result rank list better meeting demands of the user, i.e., a more targeted search result rank list, after the social application server obtains the search result including at least one piece of information, the search method according to the embodiment of the invention further includes following processing steps.

In step 504, the social application server obtains social relationship information corresponding to the user identifier in the social application and ranks the information in the search result based on the obtained social relationship information, to obtain a search result rank list.

Further, the method for the social application server to obtain the social relationship information corresponding to the user identifier in the social application includes but is not limited to: obtaining all dynamic information on the user and information on other users related to the user according to the user identifier, and regarding all the dynamic information on the user and the information on the other users related to the user as the obtained social relationship information. For example, article shared by user A, official accounts followed by user A, information on friends of user A and articles shared by the friends can be obtained through a social application account of user A.

Ranking the information in the search result based on the social relationship information to obtain the search result rank list may include but is not limited to the following steps.

A first step includes sorting the information in the search result into categories, and ranking the categories to obtain a primary search result list ranked according to the categories.

For search in the social application, the sorting the information in the search result into categories may include sorting the information in the search result into categories including contacts of the user, official accounts followed by the user, chat logs of the user, chat groups the user is in, collections of the user and related articles. The method for the sorting is not limited in the embodiment of the invention.

The categories in which the information is sorted into may be ranked in a random order, in an order of the number of strokes of names of the categories or in any other order, where the method for ranking the categories is not limited in the embodiment of the invention.

A second step includes ranking information in each of the categories in the primary search result list based on the social relationship information, to obtain the search result rank list.

Ranking the information in each of the categories in the primary search result list based on the obtained social relationship information includes: weighing the information in each of the categories in the primary search result list based on the social relationship information, to obtain a weight of each piece of information in each of the categories in the primary search result list; and ranking the information in each of the categories in the primary search result list based on the weight of each piece of information in each of the categories in the primary search result list.

Further, the information in each of the categories in the primary search result list based on the social relationship information is weighed and the weight of each piece of information in each of the categories in the primary search result is obtained. The contacts of the user and the chat groups the user is in may be ranked according to frequencies that the user contacts the contacts or the user uses the chat groups, where contacts and chat groups with higher frequencies are ranked at the top, contacts and chat groups with lower frequencies are ranked at the bottom. The official accounts followed by the user may be ranked according to time when the user starts to follow the official accounts, where official accounts recently followed are ranked at the top and official accounts previously are ranked at the bottom. The chat logs of the user may be ranked in chronological order of the chat logs, where recent chat logs are ranked at the top and previous chat logs are ranked at the bottom. The collections of the user may be ranked by the quantities of related contents in each collection, where collections with more related contents are ranked at the top and collections with less related contents are ranked at the bottom. For the related articles, articles collected and shared with friends are ranked first, articles published by the official accounts followed by the user are ranked second. Subsequently, articles which include keyword information in the titles are ranked third and articles which include keyword information in the bodies are ranked last.

Weights may be assigned to the factors above affecting the rank result, and scores of the factors in each piece of information are calculated according to a certain score calculating rule. The weights and the scores of the factors affecting the rank result in each piece of information are multiplied together to obtain respective products and the products of all the factors are added up to obtain an importance score of each piece of information.

The ranking the information in each of the categories in the primary search result list based on the weight of each piece of information in each of the categories in the primary search result list includes but is not limited to: ranking information with a high importance score at the top and ranking information with a low importance score at the bottom, to obtain the search result rank list.

It should be noted that since different users have different social relationship information, different users inputting the same first-order search keyword will have different search result rank lists after the search result relevant to the first-order search keyword is ranked based on social relationship information of the users.

For example, in a case of searching for article information, when users search with keywords “** application”, contents preferentially seen by different users are different. In a case that the user is an internet practitioner, when the user searches with “** application”, the user will preferentially see articles on latest development of ** application and cooperation between ** application and the internet industry which would probably be read, shared and collected by friends of the user. When searching with “** application”, an ordinary user may more likely seen articles titled “ten functions of ** application you do not know” and “lies of ** application in the first half of the year”. In conclusion, behaviors of friends of the user reading, sharing and collecting articles affect the search result rank list obtained by the user. For example, a user searches with keywords “alumni association” in official accounts. Supposing the user is an graduate of ** university, there must be alumni of the user in a relationship chain of the user. In a case that the alumni follow the alumni association of ** university, the official account of the alumni association of ** university is preferentially presented in the search result rank list. When searching with “alumni association” in official accounts, users from different universities can preferentially find official accounts of alumni associations of their own universities.

In order that the social application server can differentiate different categories of information in the search result rank list, the search method further includes adding category identifiers for the categories in the search result rank list, so that the social application server can differentiate different categories of information in the search result rank list based on the category identifiers corresponding to the categories.

In step 505, the social application server sends the search result rank list as a search result rank list to the social application client.

The method for the social application server to send the search result rank list as a search result rank list to the social application client is not limited in the embodiment. The search result rank list may be sent to the social application client through a wired network or a wireless network.

In step 506, the social application client receives and displays the search result rank list from the social application client.

The social application server obtains the search result rank list by ranking the information corresponding to the first-order search keyword based on the social relationship information corresponding to the user identifier in the social application.

The social application client displaying the search result rank list received from the social application server includes but is not limited to: displaying the search result rank list according to the categories in the search result rank list.

The displaying the search result rank list according to the categories in the search result rank list include but is not limited to; displaying a predetermined amount of information in each of the categories in the search result rank list; hiding information beyond the predetermined amount of information in each of the categories; and displaying a viewing entry of each of the categories.

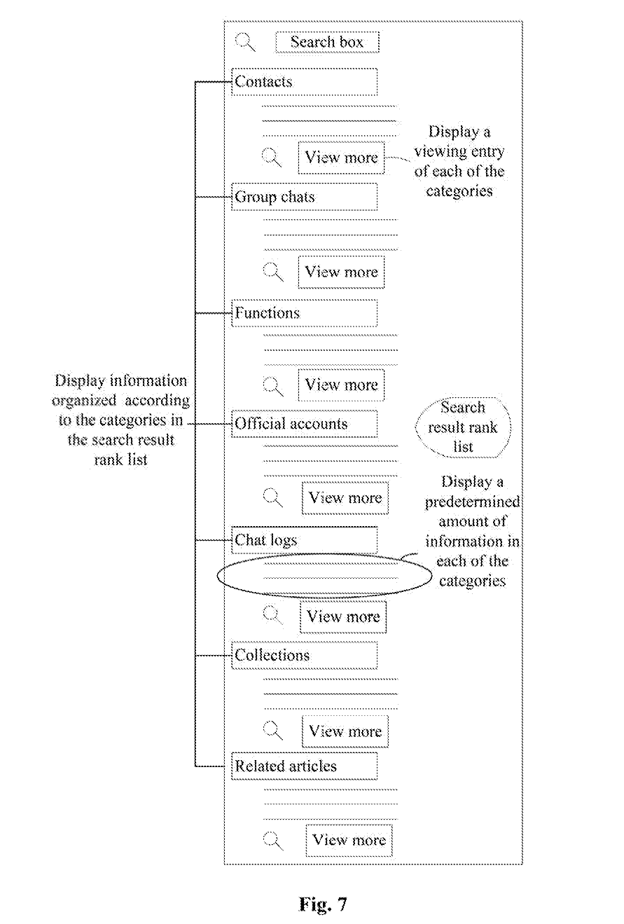

The predetermined amount is not specifically limited in the embodiment of the invention. For example, for the display interface as shown in FIG. 7, in a case that the predetermined amount of information in each of the categories displayed on the display interface is three pieces of information, three pieces of information in the category of related articles in the search result rank list is displayed and other information beyond the three pieces of information in the category of related articles is hidden.

Further, after displaying the viewing entry of each of the categories, the search method further includes: detecting whether the viewing entry of each of the categories is selected; and after detecting that a viewing entry of one of the categories is selected, displaying the remaining information (which has not been displayed) in the category corresponding to the selected viewing entry. The method for detecting whether the viewing entry is selected is not limited in the embodiment.

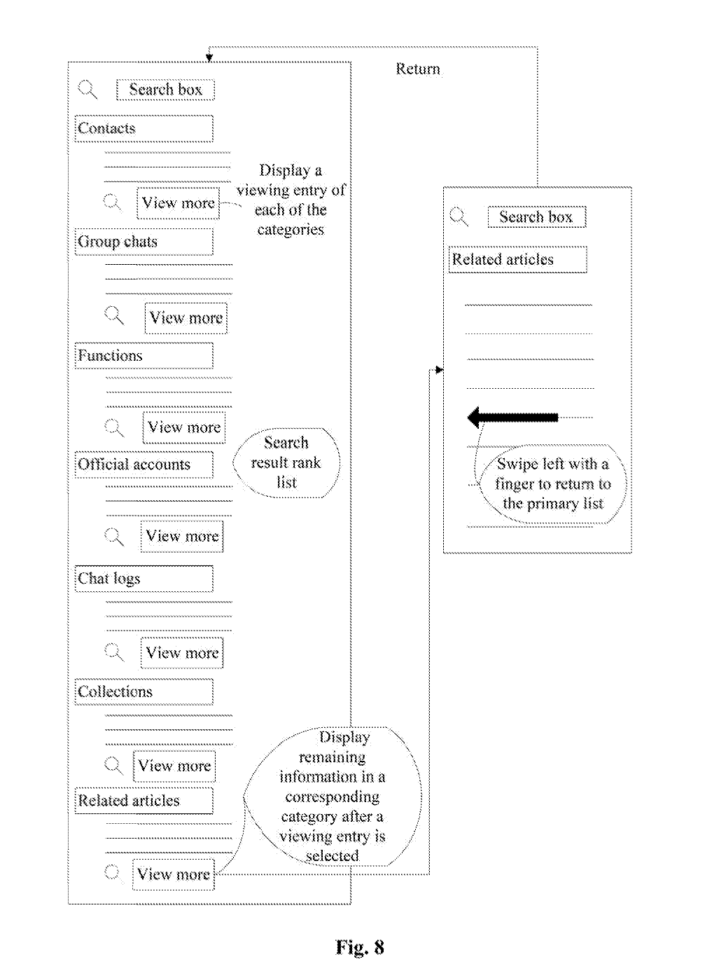

For example, for the display interface as shown in FIG. 8, after a viewing entry of the category of related articles in the search result rank list is selected, the remaining information (which has not been displayed) in the category of related articles is displayed.

After detecting that a viewing entry of one of the categories is selected, the search method further includes: obtaining a second-order search keyword inputted by the user in the category corresponding to the selected viewing entry; sending the second-order search keyword and a category identifier of the category corresponding to the selected viewing entry to the social application server; receiving a rank result obtained by the social application server by ranking information corresponding to the second-order search keyword based on the social relationship information after searching for the information corresponding to the second-order search keyword in the category corresponding to the category identifier, and displaying the rank result from the social application server.

The method for obtaining the second-order search keyword inputted by the user in the category corresponding to the selected viewing entry is the same as the method for obtaining the first-order search keyword inputted by the user, which is not specifically limited in the embodiment. And the method for sending the second-order search keyword and the category identifier of the category corresponding to the selected viewing entry to the social application server is also not limited.

After the social application server sends the search result rank list to the social application client, the search method further includes: receiving the category identifier and the second-order search keyword from the social application client; searching for the information corresponding to the second-order search keyword in the category corresponding to the category identifier; and ranking the information corresponding to the second-order search keyword based on the social relationship information and sending the obtained rank result to the social application client.

The social application server may search for the information corresponding to the second-order search keyword in the category corresponding to the category identifier by using the method above for searching for the first-order search keyword, or by using any other method, which is not limited in the embodiment. Besides, the social application server may rank the information corresponding to the second-order search keyword based on the social relationship information by using the method above for ranking the information corresponding to the first-order search keyword based on the social relationship information, or by using any other method, which is not limited in the embodiment either.

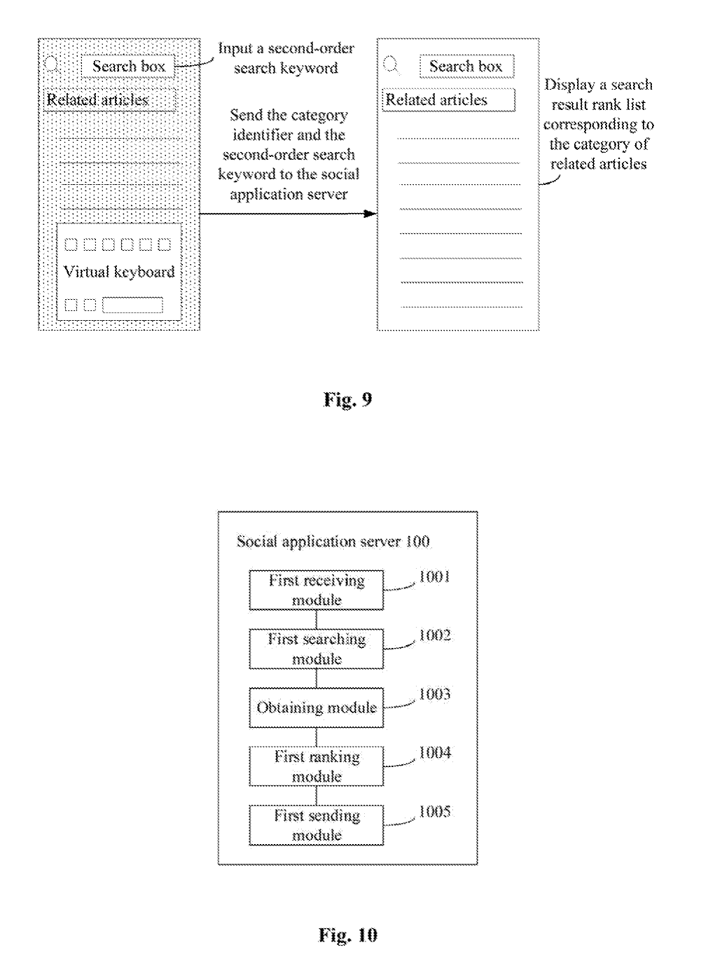

For example, the display interface as shown in FIG. 9 is taken as an example. After the user inputs a second-order search keyword in the category of related articles in the search result rank list, the social application client sends the second-order search keyword inputted by the user and a category identifier to the social application server. After the social application server sends an obtained rank result to the social application client, the social application client displays a search result rank list corresponding to the category of related articles.

In an optional embodiment, as shown in FIG. 8, when intending to return to the primary search result rank list from the category corresponding to the selected viewing entry, the user can swipe left on the interface with a finger.

In an optional embodiment, since information in the internet is always changing, a refreshing button is provided on an interface for inputting the search result rank list to update information search result in a real-time manner. In a case that the social application client detects that the user taps the refreshing button with a finger, it is equivalent to that the original search keyword is obtained and sent to the social application server again. Then the social application server conducts a search again with original operations to obtain a latest search result rank list and sends the same to the social application client.

As shown in FIG. 10, a social application server 100 is provided according to an embodiment of the invention, where the social application server 100 is applied to information search in a social application and configured to implement the functions of the social application server in the search method according to any of the embodiments shown in FIGS. 2 to 5. The social application server 100 includes:

a first receiving module 1001, configured to receive a first-order search keyword and a user identifier from a social application client;

a first searching module 1002, configured to search for information relevant to the first-order search keyword, to obtain a search result including at least one piece of information;

an obtaining module 1003, configured to obtain social relationship information corresponding to the user identifier in the social application;

a first ranking module 1004, configured to rank information in the search result based on the social relationship information, to obtain a search result rank list; and

a first sending module 1005, configured to send the search result rank list to the social application client.

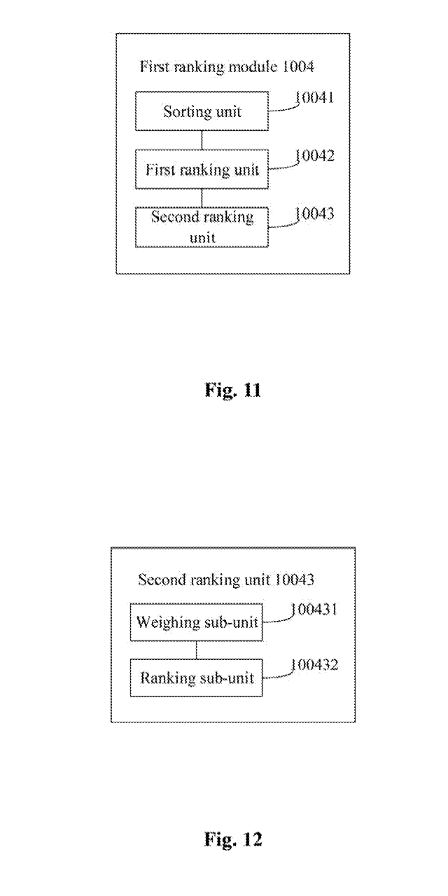

Further, as shown in FIG. 11, the first ranking module 1004 includes:

a sorting unit 10041, configured to sort the information in the search result into categories;

a first ranking unit 10042, configure to rank the categories to obtain a primary search result list ranked according to the categories; and

a second ranking unit 10043, configured to rank information in each of the categories in the primary search result list based on the social relationship information, to obtain the search result rank list.

Further, as shown in FIG. 12, the second ranking unit 10043 includes:

a weighing sub-unit 100431, configured to weigh the information in each of the categories in the primary search result list based on the social relationship information, to obtain a weight of each piece of information in each of the categories in the primary search result list; and

a ranking sub-unit 100432, configured to rank the information in each of the categories in the primary search result list based on the weight of each piece of information in each of the categories in the primary search result list.

Further, the search result rank list obtained by the first ranking module 1004 includes category identifiers corresponding to the categories.

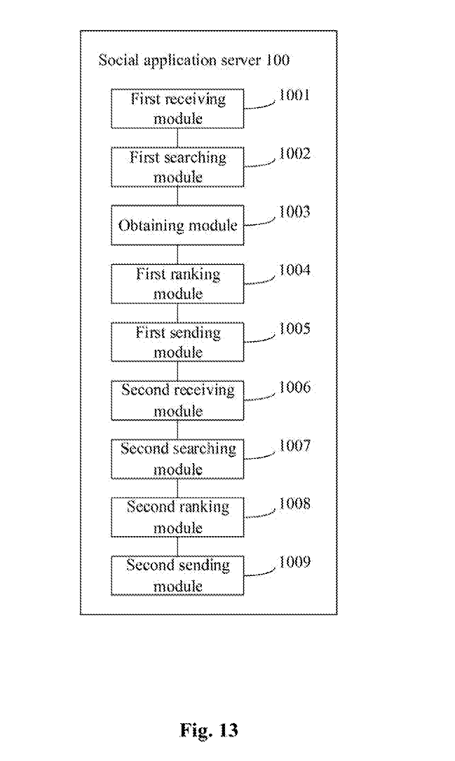

Further, as shown in FIG. 13, the social application server 100 further includes:

a second receiving module 1006, configured to receive a category identifier and a second-order search keyword from the social application server;

a second searching module 1007, configured to searching for information corresponding to the second-order search keyword in a category corresponding to the category identifier;

a second ranking module 1008, configured to rank the information corresponding to the second-order search keyword based on the social relationship information; and

a second sending module 1009, configured to send an obtained rank result to the social application client.

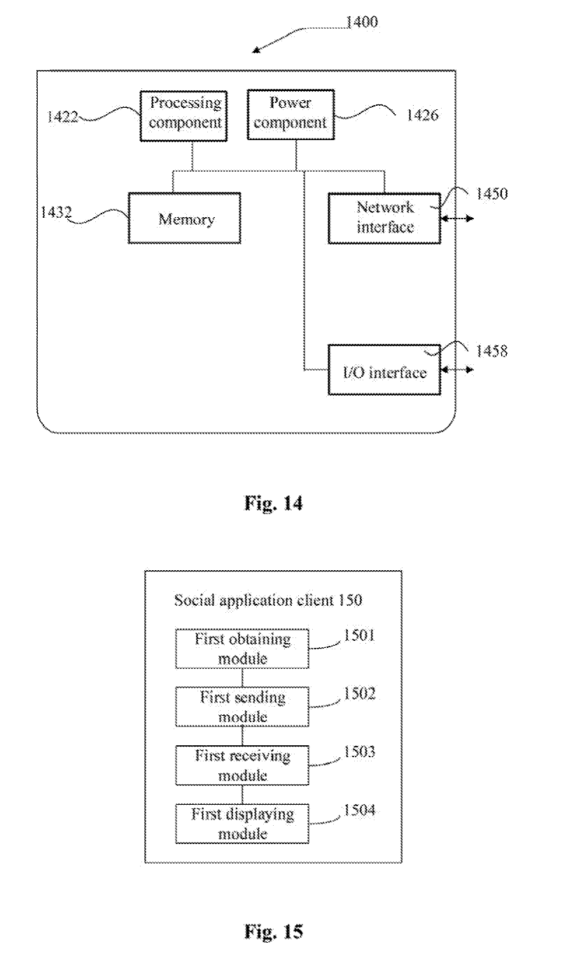

FIG. 14 is a schematic diagram of a social application server according to an embodiment. As shown in FIG. 14, the server 1400 includes a processing component 1422 including one or more processors, and memory resources represented by a memory 1432, which is configured to store instructions executable by the processing component 1422, for example, application programs. The application programs stored in the memory 1432 may include one or more modules, each of which corresponds to a group of instructions. In addition, the processing component 1422 is configured to execute the instructions, to implement the functions of the social application server in the method according to any of the embodiments shown in FIGS. 2 to 5.

The server 1400 may further include a power component 1426 configured to implement power management of the serve 1400, a wired or wireless network interface 1450 configured to connect the server 1400 to a network, and an input/output interface 1458. The server 1400 may operate based on an operating system stored in the memory 1432, such as Windows Server™, Mac OS X™, Unix™, Linux™, FreeBSD™ or the like.

One or more programs are stored in the memory and configured to be performed by the one or more processors, where instructions for performing the following operations are included in the one or more programs;

receiving a first-order search keyword and a user identifier from a social application client;

searching for information relevant to the first-order search keyword, to obtain a search result including at least one piece of information;

obtaining social relationship information corresponding to the user identifier in the social application, and ranking information in the search result based on the social relationship information, to obtain a search result rank list;

sending the search result rank list to the social application client.

Supposing the above is a first possible implementation, in a second possible implementation based on the first possible implementation, the memory of the server further includes instructions for performing the following operations:

sorting the information in the search result into categories, and ranking the categories to obtain a primary search result list ranked according to the categories; and

ranking information in each of the categories in the primary search result list based on the social relationship information, to obtain the search result rank list.

In a third possible implementation based on the second possible implementation, the memory of the server further includes instructions for performing the following operations:

weighing the information in each of the categories in the primary search result list based on the social relationship information, to obtain a weight of each piece of information in each of the categories in the primary search result list; and

ranking the information in each of the categories in the primary search result list based on the weight of each piece of information in each of the categories in the primary search result list.

In a fourth possible implementation based on the second or the third possible implementation, the search result rank list further comprises category identifiers corresponding to the categories,

the memory of the server further includes instructions for performing the following operations:

after sending the search result rank list to the social application client,

obtaining a category identifier and a second-order search keyword from the social application client;

searching for information corresponding to the second-order search keyword in a category corresponding to the category identifier; and

ranking the information corresponding to the second-order search keyword based on the social relationship information and sending an obtained rank result to the social application client.

As shown in FIG. 15, a social application client 150 is provided according to an embodiment of the invention, which is applied to information search in a social application and configured to implement the functions of the social application client in the search method according to any of the embodiments shown in FIGS. 2 to 5. The social application client 150 includes:

a first obtaining module 1501, configured to obtain a user identifier of a user and a first-order search keyword inputted by the user;

a first sending module 1502, configured to send the first-order search keyword and the user identifier to a social application server;

a first receiving module 1503, configured to receive a search result rank list from the social application server, where the search result rank list is obtained by ranking, by the social application server, information corresponding to the first-order search keyword based on social relationship information corresponding to the user identifier in the social application; and

a first displaying module 1504, configured to display the search result rank list received from the social application server.

Further, the first sending module 1502 is specifically configured to send the first-order search keyword and the user identifier to the social application server when receiving no input from the user for a predetermined time after the user inputs at least two characters for the first-order keyword.

Further, the first displaying module 1504 is specifically configured to display the search result rank list according to categories in the search result rank list.

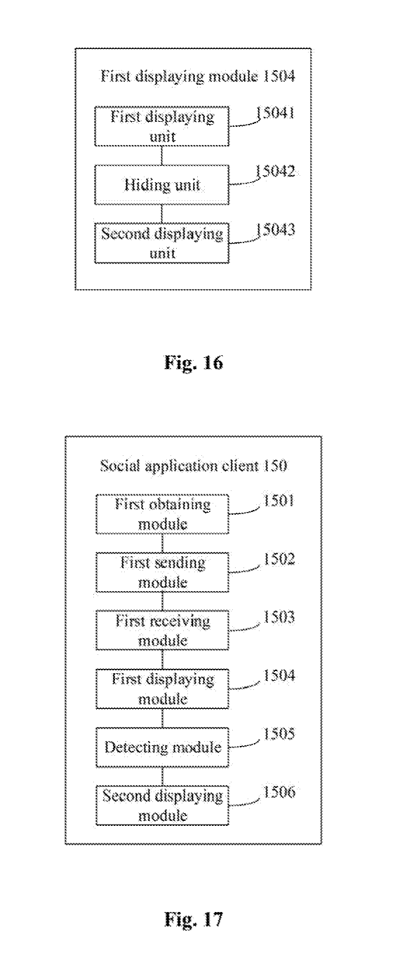

Further, as shown in FIG. 16, the first displaying module 1504 includes:

a first displaying unit 15041, configured to display a predetermined amount of information in each of the categories in the search result rank list;

a hiding unit 15042, configured to hide information beyond the predetermined amount of information in each of the categories; and

a second displaying unit 15043, configured to display a viewing entry of each of the categories.

Further, as shown in FIG. 17, the social application client 150 further includes:

a detecting module 1505, configured to detect whether the viewing entry of each of the categories is selected;

a second displaying module 1506, configured to, in response to detecting that the viewing entry of one of the categories is selected, display other information not displayed in the one of the categories corresponding to the selected viewing entry.

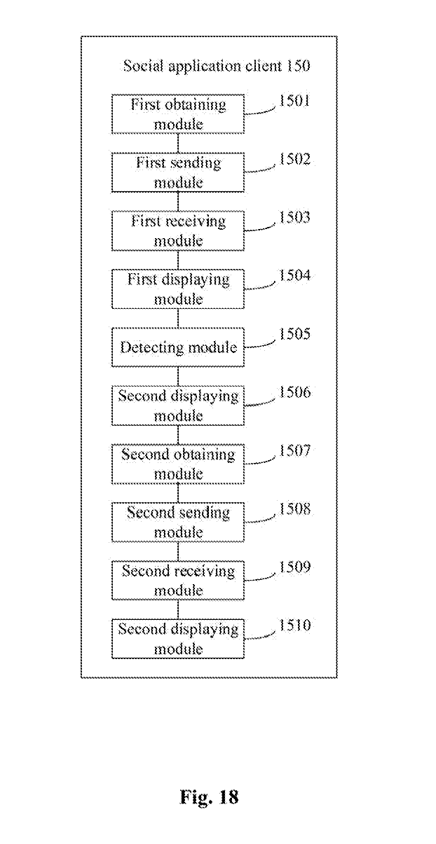

Further, as shown in FIG. 18, the social application client 150 further includes;

a second obtaining module 1507, configured to obtain a second-order search keyword, in the category corresponding to the selected viewing entry, inputted by the user;

a second sending module 1508, configured to send the second-order search keyword and a category identifier of the category corresponding to the selected viewing entry to the social application server;

a second receiving module 1509, configured to receiving a rank result obtained by the social application server by ranking information corresponding to the second-order search keyword based on the social relationship information after searching for the information corresponding to the second-order search keyword in the category corresponding to the category identifier; and

a second displaying module 1510, configured to display the rank result from the social application server.

A terminal is provided according to an embodiment of the invention, which can be configured to implement the functions of the social application client in the search method according to any of the embodiments shown in FIGS. 2 to 5.

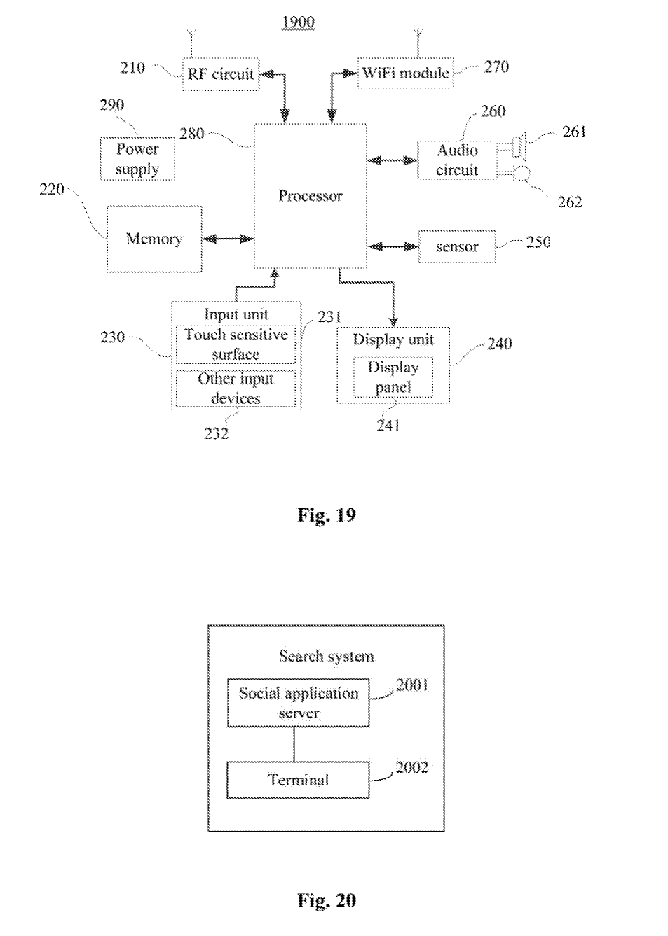

As shown in FIG. 19, the terminal 1900 may include a RF (radio frequency) circuit 210, a memory 220 including one or more computer readable storage media, an input unit 230, a display unit 240, a sensor 260, an audio circuit 206, a WiFi (Wireless Fidelity) module 270, a processor 280 including one or more processing cores and a power supply 290. Those in the art shall understand the terminal structure shown in FIG. 19 is not constructed as a limit to the terminal, which may include more or less components than shown in FIG. 19, combinations of some of the components, or different components arrangements.

The RF circuit 210 can be configured to receive and send a signal in the process of receiving and sending information, particularly, receiving downlink information of a base station and transferring the downlink information to one or more processors 280 to process; and, in addition, send uplink-related data to the base station. Generally, the RF circuit 210 includes but is not limited to an antenna, at least one amplifier, a tuner, one or more oscillators, a user identity module (SIM) card, a transceiver, a coupler, a LNA (low noise amplifier) and a duplexer. Besides, the RF circuit 210 may communicate with other devices through wireless communications or a network. The wireless communications may adopt any communications standard or protocol, which includes but is not limited to GSM (Global System of Mobile communication), GPRS (General Packet Radio Service), CDMA (Code Division Multiple Access), WCDMA (Wideband Code Division Multiple Access), LTE (Long Term Evolution), e-mail and SMS (Short Messaging Service).

The memory 220 can be configured to store software programs and modules, and the processor 280 performs various functional applications and data processing by running the software programs and modules stored in the memory 220. The memory 220 may mainly include a program storage zone and a data storage zone, where operating systems, applications programs required by at least one function (such as an audio playing function and an image playing function) may be stored in the program storage zone and data (such as audio data and phone directories) created in the usage of the terminal 1900 may be stored in the data storage zone. Besides, the memory 220 may include a high-speed random access memory, and further include a nonvolatile memory, such as at least one magnetic disk memory, a flash memory or any other nonvolatile solid memory. Accordingly, the memory 220 may further include a memory controller, to provide an access to the memory 220 for the processor 280 and the input unit 230.

The input unit 230 can be configured to receive inputted figures or character information and generate a keyboard, mouse, operating leveler, optical or trackball signal input related to user settings and function control. Specifically, the input unit 230 may include a touch sensitive surface 231 and other input devices 232. The touch sensitive surface 231, also called a touch screen or a touch panel, can collect an operation thereon or nearby (for example, an operation of a user with any appropriate object or accessory such as a finger or a touch pen on or near the touch sensitive surface 231) and drive a corresponding connection device according to a preset procedure. Optionally, the touch sensitive surface 231 may include a touch detecting apparatus and a touch controller. The touch detecting apparatus detects a position of a touch operation by a user and a signal brought in by the touch operation, and sends the signal to the touch controller. The touch controller receives touch information from the touch detecting apparatus, converts the touch information into a coordinate of a touch point, sends the coordinate of the touch point to the processor 280, receives and executes commands from the processor 280. Besides, the touch sensitive surface 231 may be a resistive, capacitive, infrared or surface acoustic wave touch sensitive surface. In addition to the touch sensitive surface 231, the input unit 230 may further include other devices 232. The other devices 232 may include but are not limited to one or more of a physical keyboard, a functional button (such as a volume control button or a switch button), a trackball, a mouse and an operating lever.

The display unit 240 can be configured to display information inputted by the user or provided for the user, and various graphic user interfaces of the terminal 1900, where the graphic user interfaces may include images, texts, icons, videos and arbitrary combinations thereof. The display unit 240 may include a display panel 241, which, optionally, may be configured in the form of LCD (liquid crystal display) or OLED (organic light-emitting diode).

Further, the display panel 241 may be covered by the touch sensitive surface 231. After detecting a touch operation thereon or nearby, the touch sensitive surface 231 sends the touch operation to the processor 280 to determine a type of the touch event, and then the processor 280 provides a corresponding visual output on the display panel 241 according to the type of the touch event. Although in FIG. 19 the touch sensitive surface 231 and the display panel 241 implement an input and output function as two independent components, the touch sensitive surface 231 and the display panel 241 may be integrated together to implement the input and output function in some embodiments.

The terminal 1900 may further include at least one sensor 250, such as a light sensor, a motion sensor and any other sensor. Specifically, the light sensor may include an environmental light sensor and a proximity sensor. The environmental light sensor can adjust a lightness of the display panel 241 according to a brightness of environmental light, and the proximity sensor can turn off at least one of the display panel and a backlight of the display panel when the terminal 1900 is moved close to an ear. As one kind of the motion sensor, an accelerometer sensor can detect values of accelerations in various directions (generally in three axes), and detect a value and a direction of gravity when being motionless, which can be applied to applications of recognizing a gesture of a cellphone (such as switching between landscape mode and portrait mode, related games and magnetometer calibration) and related functions of vibration recognition (such as a pedometer and a knock). Other sensors which may be included in the terminal 1900, such as a gyroscope, a barometer, a hygrometer, a thermometer and an infrared sensor are not described herein redundantly.

The audio circuit 260, a loudspeaker 261 and a microphone 262 can provide an audio interface between a user and the terminal 1900. The audio circuit 260 can transmit an electrical signal converted from received audio data to the loudspeaker 261, and the loudspeaker 261 then converts the electrical signal into an acoustical signal and outputs the acoustical signal. On the other hand, the microphone 262 converts a collected acoustical signal into an electrical signal; the audio circuit 260 receives the electrical signal, converts the electrical signal into audio data and sends the audio data to the processor 280; and after processing the audio data, the processor 280 sends the processed audio data to another terminal through the RF circuit 210, for example, or outputs the audio data to the memory 220 for further processing. The audio circuit 260 may further include a headset jack, to provided communications between an external headset and the terminal 1900.

WiFi is a short distance wireless transmission technology. The terminal 1900 can help the user receive and send e-mails, browse webpages and access streaming media with the WiFi module 270, which provides an access to wireless broadband internet for the user. Although the WiFi module 270 is shown in FIG. 19, it is understood that the WiFi module 270 is not a necessary part of the terminal 1900 and can be absolutely omitted without deviating from the essence of the invention.

The processor 280 is the control center of the terminal 1900, which connects all parts of the cellphone through interfaces and circuits, implements the functions of the terminal 1900 and processes data by running or executing the software programs or modules stored in the memory 220 and calling data stored in the memory 220, thereby realizing an overall monitoring on the cellphone. Optionally, the processor 280 may include one or more processing cores. Preferably, the processor 280 may be integrated with an application processor and a modulation/demodulation processor, where the application processor is mainly configured to process the operating systems, user interfaces and applications and the modulation/demodulation processor is mainly configured to process wireless communications. It is understood the modulation/demodulation processor may not be integrated into the processor 280.

The terminal 1900 further includes the power supply 290 (for example, a battery) to supply the components with power. Preferably, the power supply may be logically connected to the processor 280 through a power management system, thereby implementing functions of managing charging, discharging and power consumption with the power management system. The power supply 290 may further include any components such as one or more direct current or alternative current power supplies, a recharging system, a power failure detection circuit, a power converter or inverter and a power status indicator.

Although not shown, the terminal 1900 may further include a camera and a Bluetooth module, which is not described redundantly herein. In the embodiment, the display unit of the terminal is a touch-screen display. The terminal also includes a memory and one or more programs, where the one or more programs are stored in the memory and configured to be executed by one or more processors. The one or more programs include instructions for performing the following operations:

obtaining a user identifier of a user and a first-order search keyword inputted by the user;

sending the first-order search keyword and the user identifier to a social application server;

receiving a search result rank list from the social application server, where the search result rank list is obtained by ranking, by the social application server, information corresponding to the first-order search keyword based on social relationship information corresponding to the user identifier in a social application; and

displaying the search result rank list received from the social application server.

Supposing the above to be a first possible implementation, in a second possible implementation based on the first possible implementation, the memory further includes instructions for performing the following operation:

sending the first-order search keyword and the user identifier to the social application server when receiving no input from the user for a predetermined time after the user inputs at least two characters for the first-order keyword.

In a third possible implementation based on the first possible implementation, the memory further includes instructions for performing the following operation:

displaying the search result rank list according to categories in the search result rank list.

In a fourth possible implementation based on the third possible implementation, the memory further includes instructions for performing the following operations:

displaying a predetermined amount of information in each of the categories in the search result rank list; and

hiding information beyond the predetermined amount of information in each of the categories and displaying a viewing entry of each of the categories.

In a fifth possible implementation based on the fourth possible implementation, the memory further includes instructions for performing the following operations:

detecting whether the viewing entry of each of the categories is selected; and

in response to detecting that the viewing entry of one of the categories is selected, displaying other information not displayed in the one of the categories corresponding to the selected viewing entry.

In a sixth possible implementation based on the fifth possible implementation, the memory further includes instructions for performing the following operations:

obtaining a second-order search keyword, in the category corresponding to the selected viewing entry, inputted by the user;

sending the second-order search keyword and a category identifier of the category corresponding to the selected viewing entry to the social application server;

receiving a rank result obtained by the social application server by ranking information corresponding to the second-order search keyword based on the social relationship information after searching for the information corresponding to the second-order search keyword in the category corresponding to the category identifier; and

displaying the rank result from the social application server.

A computer readable storage medium is provided according to an embodiment of the invention, which may be the computer readable storage medium in the memory according to the embodiment above, or an independent computer storage medium which is not installed to any terminal. One or more programs are stored in the computer readable storage medium, where the one or more programs are executed by one or more processors to implement a search method, where the search method includes:

obtaining a user identifier of a user and a first-order search keyword inputted by the user;

sending the first-order search keyword and the user identifier to a social application server;

receiving a search result rank list from the social application server, where the search result rank list is obtained by ranking, by the social application server, information corresponding to the first-order search keyword based on social relationship information corresponding to the user identifier in a social application; and

displaying the search result rank list received from the social application server.

Supposing the above to be a first possible implementation, in a second possible implementation based on the first possible implementation, the computer readable storage medium further includes instructions for performing the following operation:

sending the first-order search keyword and the user identifier to the social application server when receiving no input from the user for a predetermined time after the user inputs at least two characters for the first-order keyword.

In a third possible implementation based on the first possible implementation, the computer readable storage medium further includes instructions for performing the following operation:

displaying the search result rank list according to categories in the search result rank list.

In a fourth possible implementation based on the third possible implementation, the computer readable storage medium further includes instructions for performing the following operations:

displaying a predetermined amount of information in each of the categories in the search result rank list; and

hiding information beyond the predetermined amount of information in each of the categories and displaying a viewing entry of each of the categories.

In a fifth possible implementation based on the fourth possible implementation, the computer readable storage medium further includes instructions for performing the following operations:

detecting whether the viewing entry of each of the categories is selected; and

in response to detecting that the viewing entry of one of the categories is selected, displaying other information not displayed in the one of the categories corresponding to the selected viewing entry.

In a sixth possible implementation based on the fifth possible implementation, the computer readable storage medium further includes instructions for performing the following operations:

obtaining a second-order search keyword, in the category corresponding to the selected viewing entry, inputted by the user;

sending the second-order search keyword and a category identifier of the category corresponding to the selected viewing entry to the social application server;

receiving a rank result obtained by the social application server by ranking information corresponding to the second-order search keyword based on the social relationship information after searching for the information corresponding to the second-order search keyword in the category corresponding to the category identifier; and

displaying the rank result from the social application server.

A graphic user interface is provided according to an embodiment of the invention, which is applied to a terminal including a touch-screen display, a memory and one or more processors for executing one or more programs. The graphic user interface is configured to:

obtain a user identifier of a user and a first-order search keyword inputted by the user;

send the first-order search keyword and the user identifier to a social application server;

receive a search result rank list from the social application server, where the search result rank list is obtained by ranking, by the social application server, information corresponding to the first-order search keyword based on social relationship information corresponding to the user identifier in a social application; and

display the search result rank list received from the social application server.

As shown in FIG. 20, a search system is provided according to an embodiment of the invention, which includes a social application server 2001 and a terminal 2002.

The social application server 2001 is the social application server according to any of the embodiments above, for which a reference can be made to the embodiments above, which is not redundantly described herein.

The terminal 2002 is the social application client according to any of the embodiments above, for which a reference can be made to the embodiments above, which is not redundantly described herein.

In the search method according to any of the embodiments of the present disclosure, the first-order search keyword inputted by the user and the user identifier of the user are sent to the social application server through a terminal, and a search result rank list obtained by ranking, by the social application server, the information corresponding to the first-order search keyword based on the social relationship information corresponding to the user identifier in the social application is received, achieving searching based on the social relationship information of the user, so that the search result rank list is more targeted as well as more flexible. Not only a more optimized search result rank list is obtained, but also an efficiency of obtaining relevant information is improved for the user, thus improving the search efficiency.

It should be noted that the division of the functional modules above in the social application server and the social application client according to the embodiments above is only illustrated for example. In practical applications, the functions above may be assigned to different functional modules to implement as needed, i.e., the inner structure of the apparatus is divided into different functional modules, to implement all or some of the functions described above. Besides, the social application server and the social application client according to the embodiments above fall within the same idea as the search method, and reference can be made to the method embodiments for specific implementation thereof, which is not described hem redundantly.

Serial numbers of the embodiments above according the present disclosure are only used for description, rather than representing merits of the embodiments.

Those in the art shall understand that all or some of the steps according to the embodiments above may be performed through hardware, or through related hardware under instructions of a program. The program may be stored in a computer readable storage medium, which may be a mad-only memory, a magnetic disk or an optical disc.

The embodiments above are only some preferred embodiments of the invention and are not intended to limit the invention. Any modifications, equivalent substitutions or improvements made within the spirit and principle of the invention shall fall within the scope of the invention.

What is claimed is:

1. A search method applied to a social application, comprising:
receiving a first-order search keyword and a user identifier from a social application client;
searching for information relevant to the first-order search keyword, to obtain a search result comprising at least one piece of information;
obtaining social relationship information corresponding to the user identifier in the social application;
ranking information in the search result based on the social relationship information, to obtain a search result rank list; and
sending the search result rank list to the social application client.

2. The method according claim 1, wherein the social relationship information corresponding to the user identifier in the social application is selected from a group composed of profile information registered in the social application by a user corresponding to the user identifier, a behavior of the user corresponding to the user identifier in the social application, another user related to the user corresponding to the user identifier in the social application, a behavior of the other user in the social application or arbitrary combination of the above.

3. The method according to claim 1, wherein ranking information in the search result based on the social relationship information to obtain the search result rank list comprises:
sorting the information in the search result into categories, and ranking the categories to obtain a primary search result list ranked according to the categories; and
ranking information in each of the categories in the primary search result list based on the social relationship information, to obtain the search result rank list.

4. The method according to claim 3, wherein ranking the information in each of the categories in the primary search result list based on the social relationship information comprises:
weighing the information in each of the categories in the primary search result list based on the social relationship information, to obtain a weight of each piece of information in each of the categories in the primary search result list; and
ranking the information in each of the categories in the primary search result list based on the weight of each piece of information in each of the categories in the primary search result list.

5. The method according to claim 3, wherein the search result rank list further comprises category identifiers corresponding to the categories, and after sending the search result rank list to the social application client, the method further comprises:
obtaining a category identifier and a second-order search keyword from the social application client;
searching for information corresponding to the second-order search keyword in a category corresponding to the category identifier; and
ranking the information corresponding to the second-order search keyword based on the social relationship information and sending an obtained rank result to the social application client.

6. A search method applied to a social application, comprising:
obtaining a user identifier of a user and a first-order search keyword inputted by the user;
sending the first-order search keyword and the user identifier to a social application server;
receiving a search result rank list from the social application server, wherein the search result rank list is obtained by ranking, by the social application server, information corresponding to the first-order search keyword based on social relationship information corresponding to the user identifier in the social application; and
displaying the search result rank list received from the social application server.

7. The method according to claim 6, wherein the social relationship information corresponding to the user identifier in the social application is selected from a group composed of profile information registered in the social application by the user corresponding to the user identifier, a behavior of the user corresponding to the user identifier in the social application, another user related to the user corresponding to the user identifier in the social application, a behavior of the other user in the social application or arbitrary combination of the above.

8. The method according to claim 6, wherein sending the first-order search keyword and the user identifier to the social application server comprises:
sending the first-order search keyword and the user identifier to the social application server when receiving no input from the user for a predetermined time after the user inputs at least two characters for the first-order keyword.

9. The method according to claim 6, wherein displaying the search result rank list received from the social application server comprises:
displaying the search result rank list according to categories in the search result rank list.

10. The method according to claim 9, wherein displaying the search result rank list according to categories in the search result rank list comprises:
displaying a predetermined amount of information in each of the categories in the search result rank list; and
hiding information beyond the predetermined amount of information in each of the categories and displaying a viewing entry of each of the categories.

11. The method according to claim 10, after displaying the viewing entry of each of the categories, further comprising:
detecting whether the viewing entry of each of the categories is selected; and
in response to detecting that the viewing entry of one of the categories is selected, displaying other information not displayed in the one of the categories corresponding to the selected viewing entry.

12. The method according to claim 11, after detecting the viewing entry of the one of the categories is selected, further comprising:
obtaining a second-order search keyword, in the category corresponding to the selected viewing entry, inputted by the user;
sending the second-order search keyword and a category identifier of the category corresponding to the selected viewing entry to the social application server;
receiving a rank result obtained by the social application server by ranking information corresponding to the second-order search keyword based on the social relationship information after searching for the information corresponding to the second-order search keyword in the category corresponding to the category identifier, and
displaying the rank result received from the social application server.

13. A social application server applied to a social application, comprising:
at least one processor; and
a memory storing instructions, wherein the following operations are performed when the instructions are executed by the at least one processor:
receiving a first-order search keyword and a user identifier from a social application client;
searching for information relevant to the first-order search keyword, to obtain a search result comprising at least one piece of information;
obtaining social relationship information corresponding to the user identifier in the social application;
ranking information in the search result based on the social relationship information, to obtain a search result rank list; and
sending the search result rank list to the social application client.

14. The social application server according to claim 13, wherein the following operations are further performed when the instructions are executed by the at least one processor:
sorting the information in the search result into categories;
ranking the categories to obtain a primary search result list ranked according to the categories; and
ranking information in each of the categories in the primary search result list based on the social relationship information, to obtain the search result rank list.

15. The social application server according to claim 14, wherein the following operations are further performed when the instructions are executed by the at least one processor:
weighing the information in each of the categories in the primary search result list based on the social relationship information, to obtain a weight of each piece of information in each of the categories in the primary search result list; and
ranking the information in each of the categories in the primary search result list based on the weight of each piece of information in each of the categories in the primary search result list.

16. The social application server according to claim 14, wherein the search result rank list further comprises category identifiers corresponding to the categories, and the following operations are further performed when the instructions are executed by the at least one processor:
receiving a category identifier and a second-order search keyword from the social application client;
searching for information corresponding to the second-order search keyword in a category corresponding to the category identifier; and
ranking the information corresponding to the second-order search keyword based on the social relationship information; and
sending an obtained rank result to the social application client.
